(19) United States
(12) Patent Application Publication
(10) Pub. No.: US 2026/0370357 A1
(43) Pub. Date: Nov. 19, 2026

(54) EVENT CONDITION EVALUATION BASED ON REFERENCE SIGNAL TYPE IN WIRELESS COMMUNICATIONS

(71) Applicant: LG Electronics Inc., Seoul (KR)

(72) Inventor: Sunghoon JUNG, Seoul (KR)

(21) Appl. No.: 19/142,527

(22) PCT Filed: Jan. 9, 2025
(86) PCT No.: PCT/KR2025/000543

§ 371 Date: Jun. 23, 2025

Related U.S. Application Data
(60) Provisional application No. 63/619,695, filed on Jan. 10, 2024.

(51) Int. Cl. H04B 17/318; H04B 7/06; H04L 43/062

(52) U.S. Cl. CPC H04B 17/318; H04B 7/0626; H04B 7/06968; H04L 43/062

(57) ABSTRACT

The present disclosure is related to event condition evaluation based on a reference signal type in wireless communications. According to an embodiment of the present disclosure, a method performed by a communication device comprises: receiving a configuration for reference signals of a first type and a configuration for reference signals of a second type; receiving a configuration for an event condition for at least one of the reference signals of the first type or the reference signals of the second type; obtaining measurements results for at least one of the reference signals of the first type, or the reference signals of the second type; selecting a reference signal type among the first type and the second type, based on whether a measurement result for the reference signals of the second type is available; and evaluating the event condition based on a measurement result for reference signals of the selected reference signal type.

### TECHNICAL FIELD

The present disclosure is related to event condition evaluation based on a reference signal type in wireless communications.

### BACKGROUND ART

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a communication device needs to evaluate event condition(s) based on measurement results of reference signals. The event condition may be related to reporting measurement results and/or performing mobility. Since there may be a variety of types of measurement signals, event condition evaluation based on a reference signal type may be required.

### DISCLOSURE OF INVENTION

### Solution to Problem

An aspect of the present disclosure is to provide method and apparatus for event condition evaluation based on a reference signal type in a wireless communication system.

According to an embodiment of the present disclosure, a method performed by a communication device comprises: receiving a configuration for reference signals of a first type and a configuration for reference signals of a second type; receiving a configuration for an event condition for at least one of the reference signals of the first type or the reference signals of the second type; obtaining measurements results for at least one of the reference signals of the first type, or the reference signals of the second type; selecting a reference signal type among the first type and the second type, based on whether a measurement result for the reference signals of the second type is available; and evaluating the event condition based on a measurement result for reference signals of the selected reference signal type.

According to an embodiment of the present disclosure, a method performed by a network node comprises: transmitting, to a communication device, a configuration for reference signals of a first type and a configuration for reference signals of a second type; and transmitting, to the communication device, a configuration for an event condition for at least one of the reference signals of the first type or the reference signals of the second type, wherein the communication device is configured to perform operations comprising: obtaining measurements results for at least one of the reference signals of the first type, or the reference signals of the second type; selecting a reference signal type among the first type and the second type, based on whether a measurement result for the reference signals of the second type is available; and evaluating the event condition based on a measurement result for reference signals of the selected reference signal type.

According to various embodiments, apparatuses to implement the above methods are provided.

The present disclosure may have various advantageous effects.

For example, since UE evaluates whether to trigger a measurement report based on a desirable RS, the measurement result beneficial to network can be triggered.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a conditional mobility procedure according to an embodiment of the present disclosure.

FIG. 9 shows an example of a signaling procedure for LTM according to an embodiment of the present disclosure.

FIG. 10 shows an example of a method performed by a communication device for event condition evaluation based on RS type according to an embodiment of the present disclosure.

FIG. 11 shows an example of a signal flow between a communication device and a network node for event condition evaluation based on RS type according to an embodiment of the present disclosure.

FIG. 12 shows an overall procedure for event condition evaluation according to an embodiment of the present disclosure.

FIG. 13 shows a first example of a procedure for event condition evaluation according to an embodiment of the present disclosure.

FIG. 14 shows a second example of a procedure for event condition evaluation according to an embodiment of the present disclosure.

### MODE FOR THE INVENTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

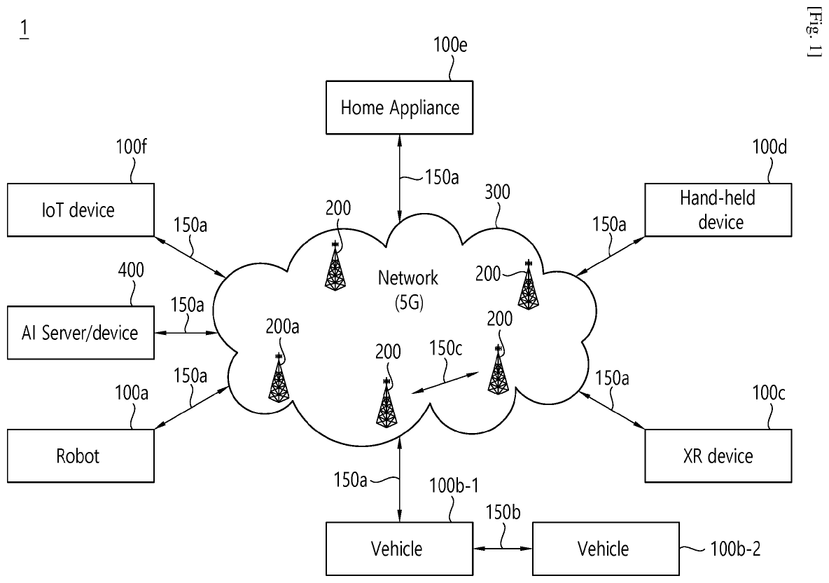

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding frequency | Subcarrier | |
|---|---|---|---|
| designation | range | Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | Subcarrier | |
|---|---|---|---|
| designation | range | Spacing | |
| FR1 | 410 MHz-7125 MHz | 15, 30, 60 | kHz |
| FR2 | 24250 MHz-52600 MHz | 60, 120, 240 | kHz |

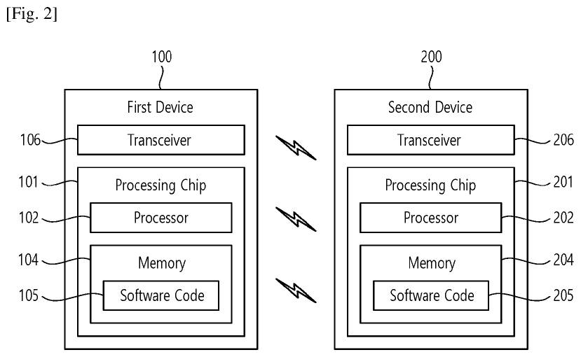

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

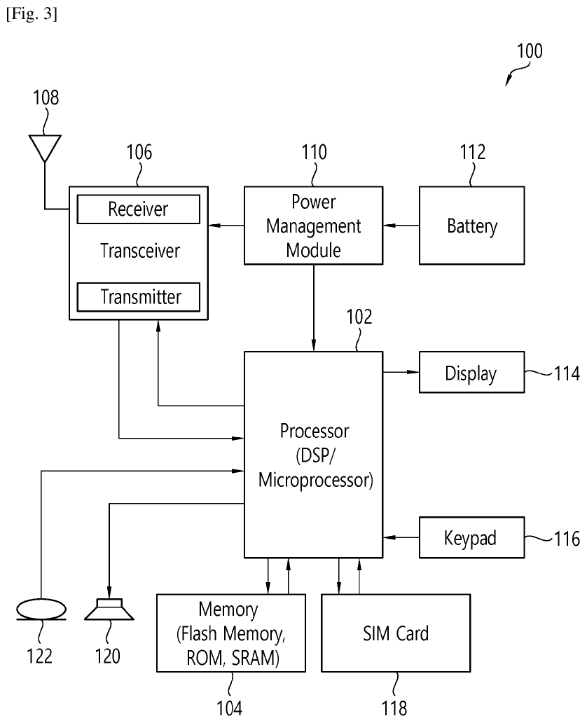

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

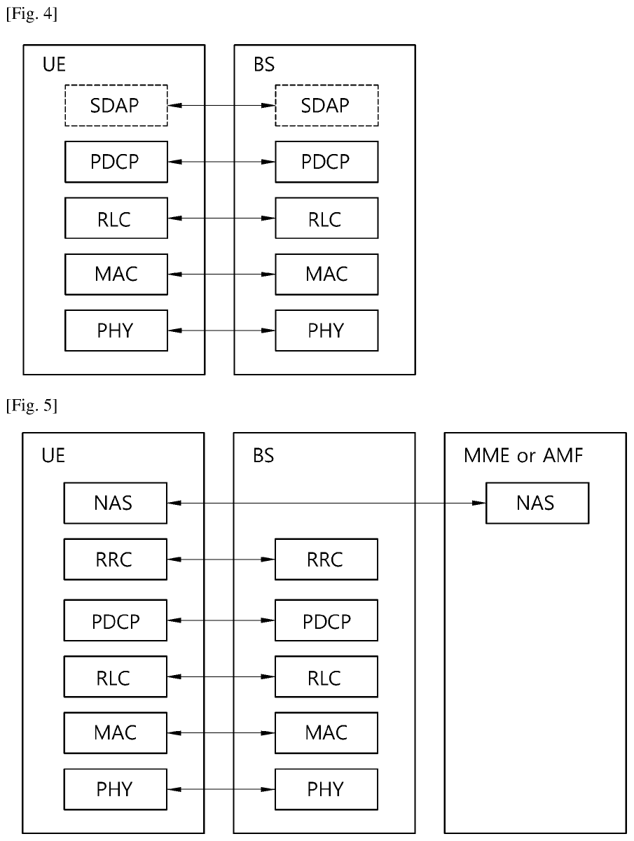

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (L1, for example PHY layer) and Layer 2 (L2, for example MAC/RLC/PDCP layer). Referring to FIG. 5, the control plane protocol stack may be divided into Layer 1 (L1, for example PHY layer), Layer 2 (L2, for example MAC/RLC/PDCP layer), Layer 3 (L3, for example an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

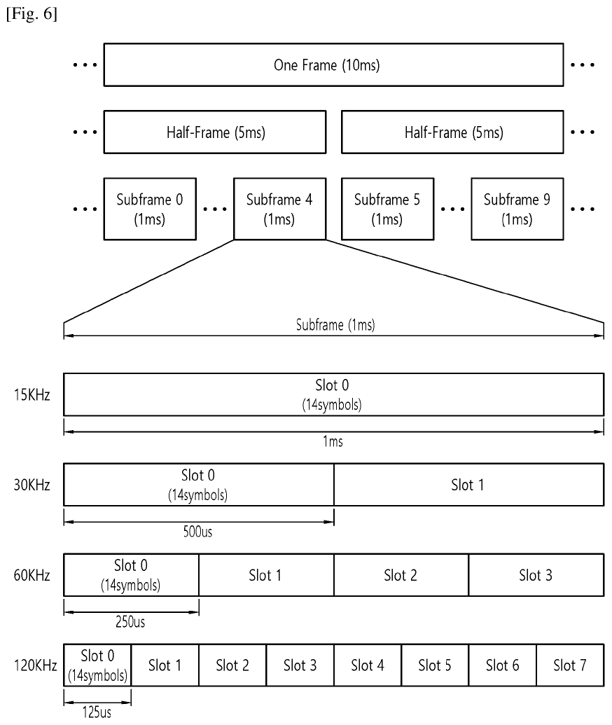

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is 1 ms, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 KHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, Where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

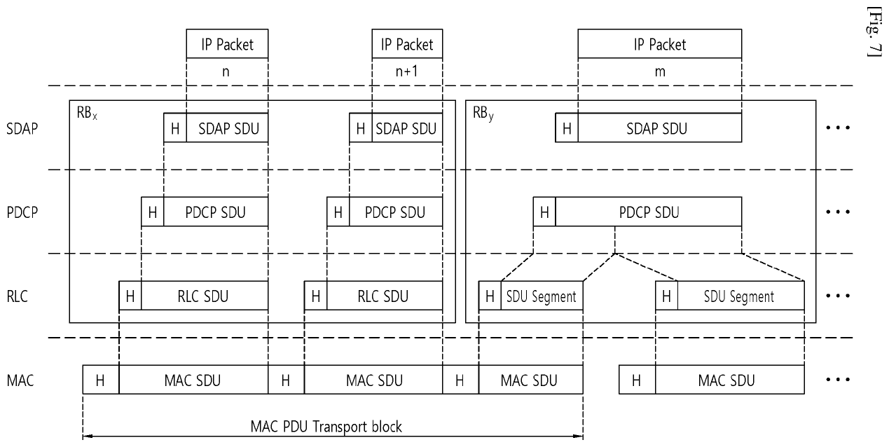

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and random access channel (RACH) are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents regarding mobility are described.

The mobility may comprise PCell change, PSCell change (or, secondary node (SN) change), and/or PSCell addition (or, SN addition).

In the present disclosure, the term “handover (HO)” may mean PCell change, or may be a broad concept that includes not only PCell change but also PSCell change/addition.

In the present disclosure, the terms “handover” and “mobility” can be used interchangeably.

In the present disclosure, the description regarding handover can also be applied to other mobility procedures (e.g., PSCell change/addition).

There may be at least two types of mobility: network-controlled mobility (or, legacy mobility) and UE-based mobility (or, conditional mobility).

The network-controlled mobility (or, legacy mobility) is a mobility where the network determines a target cell for mobility, and configures UE with the target cell. The network may transmit, to the UE, an RRCReconfiguration message comprising a configuration of the target cell. The UE may execute a mobility to the target cell and/or apply the configuration for the target cell, upon receiving the configuration of the target cell.

The UE-based mobility (or, conditional mobility) is a mobility where the network configures the UE with a plurality of candidate cells, and the UE determines a target cell which satisfies a mobility execution condition among the plurality of candidate cells. The conditional mobility may comprise at least one of a conditional PCell change/conditional handover (CHO) or a conditional PSCell mobility. The conditional PSCell mobility may comprise conditional PSCell addition/change (CPAC), including conditional PSCell addition (CPA) and/or conditional PSCell change (CPC). The network may transmit, to the UE, an RRCReconfiguration message comprising ConditionalReconfiguration information element (IE) (or, conditional mobility configuration), which comprises a list of conditional reconfigurations for the plurality of candidate cells. A conditional reconfiguration for a candidate cell may comprise an identifier of the conditional reconfiguration, a mobility execution condition for the candidate cell, and a configuration for the candidate cell. The UE may evaluate the mobility execution conditions for the plurality of candidate cells, and when a mobility execution condition for a candidate cell is satisfied, the UE may consider the candidate cell as a target cell, and execute a mobility to the target cell and/or apply the configuration for the target cell.

According to various embodiments, the mobility execution condition may be satisfied/met when an entry condition (or, entering condition) for the mobility execution condition is satisfied/met for at least a time-to-trigger (TTT) for the mobility execution condition. The entry condition/entering condition may mean that the mobility execution condition is initially met. Once the entry condition is met, the mobility execution condition will be considered to be met if the entry condition is met for time duration TTT continuously.

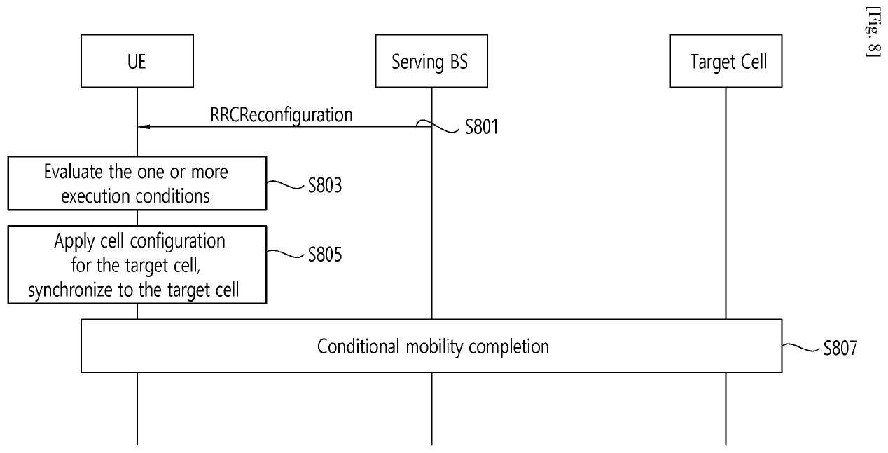

FIG. 8 shows an example of a conditional mobility procedure according to an embodiment of the present disclosure.

In FIG. 8:
the serving BS may be related to a PCell, which may be a source PCell for CHO;
the serving BS may be an MN associated with an SN in DC, where the SN may be related to a source PSCell for CPC; and
the target cell may be a target PCell for CHO, or a target PSCell for CPA/CPC.

Referring to FIG. 8, in step S801, UE may receive, from the serving BS, an RRCReconfiguraiton message comprising a conditional reconfiguration information element (IE) (i.e., CondidtionalReconfiguration). The conditional reconfiguration IE may comprise a list of conditional reconfigurations for candidate cells including the target cell. Each conditional reconfiguration in the list may be related to the corresponding candidate cell, and comprises i) an identifier of the corresponding conditional reconfiguration (i.e., condReconfigId), ii) one or more execution conditions for the corresponding candidate cell (i.e., condExecutionCond), and/or iii) RRC reconfiguration for the corresponding candidate cell (i.e., condRRCReconfig) including a configuration of the corresponding candidate cell (e.g., candidate cell configuration/target cell configuration). The one or more execution conditions may comprise CHO execution condition(s), CPA execution condition(s), and/or CPC execution condition(s).

In step S803, the UE may start evaluating the one or more execution conditions for the candidate cells.

In step S805, if the target cell satisfies the corresponding execution condition(s), the UE may execute the conditional mobility towards the target cell and/or apply the RRC reconfiguration for the target cell including a configuration of the target cell. When/upon executing the conditional mobility and/or applying the RRC reconfiguration (e.g., RRCReconfiguration including Reconfiguration WithSync) for the target cell, the UE may start a timer (e.g., T304 timer). The timer value of the T304 timer (i.e., T304 timer value) for the target cell may be included in the Reconfiguration WithSync in RRCReconfiguration for the target cell.

While the timer is running, the UE may perform DL synchronization and/or UL synchronization (e.g., random access) towards the target cell. The UE may skip the random access towards the target cell if timing advance (TA) information for the target cell is available.

In step S807, the UE, serving BS and/or BS related to the target cell may perform actions related to conditional mobility completion. For example, upon successful completion of the random access on the corresponding target cell, the UE may stop the timer (e.g., T304 timer).

Further, there may be another type of mobility called L1/L2-triggered mobility (LTM) (or, cell switch). LTM is a procedure in which a gNB receives L1 measurement report(s) from a UE, and on their basis the gNB changes UE's serving cell by a cell switch command signalled via a MAC CE. The cell switch command indicates an LTM candidate cell configuration that the gNB previously prepared and provided to the UE through RRC signalling. Then the UE switches to the target cell according to the cell switch command. The LTM procedure can be used to reduce the mobility latency.

When configured by the network, it is possible to activate TCI states of one or multiple cells that are different from the current serving cell. For instance, the TCI states of the LTM candidate cells can be activated in advance before any of those cells become the serving cell. This allows the UE to be DL synchronized with those cells, thereby facilitating a faster cell switch to one of those cells when cell switch is triggered.

When configured by the network, it is possible to initiate UL TA acquisition procedure to one or multiple cells that are different from the current serving cell. For instance, the network may request the UE to perform early TA acquisition of a candidate cell before a cell switch. The early TA acquisition is triggered by PDCCH order or realized through UE-based TA measurement. In the former case, the gNB to which the candidate cell belongs calculates the TA value and sends it to the gNB to which the serving cell belongs. The serving cell sends the TA value in the LTM cell switch command MAC CE when triggering LTM cell switch. In the latter case, the UE applies the TA value measured by itself and performs RACH-less LTM upon receiving the cell switch command.

If UE-based TA measurement is configured, UE performs RACH-less LTM upon receiving the cell switch command. Otherwise, UE determines whether to access the target cell with the RA procedure depending on whether a TA value is provided in the cell switch command. For RACH-less LTM, the UE accesses the target cell via a configured grant provided in the LTM candidate cell configuration and selects the configured grant occasion associated with the beam (or, SSB/CSI-RS) indicated in the cell switch command. If the LTM candidate cell configuration does not include a configured grant, the UE monitors PDCCH for dynamic scheduling from the target cell upon LTM cell switch. Before RACH-less LTM procedure completion, the UE shall not trigger random access procedure if it does not have a valid PUCCH resource for triggered SRs.

The following principles apply to LTM:
The UE doesn't update its security key after an intra-gNB LTM cell switch.
Subsequent LTM is supported.

LTM supports both intra-gNB-DU and intra-gNB-CU inter-gNB-DU mobility. LTM supports both intra-frequency and inter-frequency mobility, including mobility to inter-frequency cell that is not a current serving cell. The following scenarios are supported:
PCell change in non-CA scenario and non-DC scenario,
PCell change in CA scenario,
Dual connectivity scenario, MCG PCell change and SCG PSCell change without MN involvement case (i.e., intra-SN PSCell change).

While the UE has stored LTM candidate cell configurations the UE can also execute any L3 handover command sent by the network. It is up to the network to avoid any issue due to a collision between LTM execution and L3 handover execution, e.g., avoiding sending LTM cell switch command and L3 handover command simultaneously.

Cell switch command is conveyed in a MAC CE, which contains the necessary information to perform the LTM cell switch.

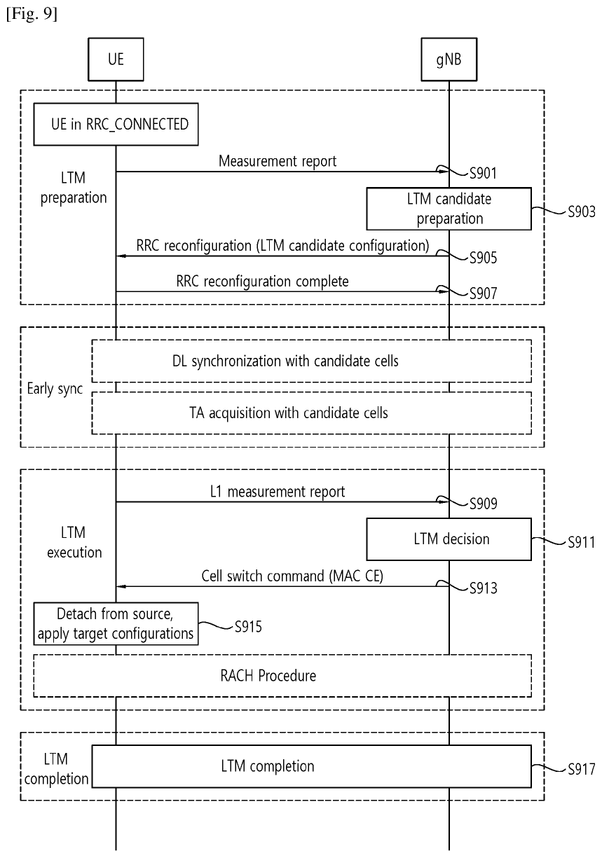

The overall procedure for LTM is shown in FIG. 9 below. Subsequent LTM is done by repeating the early synchronization, LTM cell switch execution, and LTM cell switch completion steps without releasing other LTM candidate cell configurations after each LTM cell switch completion.

FIG. 9 shows an example of a signaling procedure for LTM according to an embodiment of the present disclosure.

Referring to FIG. 9, in step S901, The UE sends a MeasurementReport message to the gNB.

In step S903, the gNB decides to configure LTM and initiates candidate cell(s) preparation.

In step S905, the gNB transmits an RRCReconfiguration message to the UE including the LTM candidate cell configurations of one or multiple candidate cells. The RRCReconfiguration message comprise an LTM configuration/cell switch configuration (e.g., LTM-Config) comprising a list of LTM candidate configurations. That is, the network configures the UE with one or more LTM candidate configurations within the LTM-Config IE. The UE stores the LTM configuration/cell switch configuration comprising the list of LTM candidate configurations.

In NR-DC, the UE may receive two independent ltm-Config:
an ltm-Config associated with the MCG that is included within an RRCReconfiguration message received via SRB1; and
an ltm-Config associated with the SCG that is included within an RRCReconfiguration message either received via SRB3, or, alternatively, embedded in an RRCReconfiguration message received via SRB1.

In this case (i.e., when the UE received two independent ltm-Config):
the UE maintains two independent VarLTM-Config, one associated with each ltm-Config;
the UE maintains two independent VarLTM-ServingCellNoResetID, one associated with each ltm-Config;
the UE maintains two independent VarLTM-ServingCellUE-MeasuredTA-ID, one associated with each ltm-Config; and/or
the UE independently performs all the procedures for each ltm-Config and the associated VarLTM-Config, unless explicitly stated otherwise.

The LTM-Config may comprise at least one of:
ltm-ReferenceConfiguration: LTM reference configuration used to provide a configuration that is common, within the same cell group, to all configured non-complete LTM candidate configurations;
ltm-CandidateToAddModList: a list of LTM candidate configurations (e.g., LTM-Candidate(s));
ltm-CandidateToReleaseList: a list of LTM candidate configuration IDs (e.g., LTM-CandidateId(s)) related to LTM candidate configurations to remove;
ltm-ServingCellNoResetID: serving cell ID based on which the UE determines whether a L2 reset is needed or not upon an LTM cell switch procedure; or
ltm-ServingCellUE-MeasuredTA-ID: serving cell ID based on which the UE determines whether UE-based TA measurements are needed or not.

The LTM-Candidate (i.e., LTM candidate configuration/candidate configuration/candidate cell configuration) may be related to a candidate (target) cell, and comprise at least one of:
ltm-CandidateId: an ID used to identify an LTM candidate configuration;
ltm-CandidateConfig: a configuration of the related candidate cell for LTM, comprising RRCReconfiguration message to be applied when LTM/cell switch is executed;
ltm-ConfigComplete: if included in the LTM-Candidate, the UE may consider that the related ltm-CandidateConfig is a complete configuration of the related candidate cell for LTM;
ltm-NoResetID: if this field is equal to ltm-ServingCellNoResetID, UE may determine that L2 reset is needed upon an LTM cell switch procedure; or
ltm-UE-MeasuredTA-ID: if this field is equal to ltm-ServingCellNoResetID, UE may determine that the UE-based TA measurements are needed.

The UE shall perform the following actions based on the received LTM-Config IE:
1> if the received LTM-Config includes ltm-ReferenceConfiguration:
2> if the current VarLTM-Config includes an ltm-Reference Configuration:
3> replace the ltm-ReferenceConfiguration value within VarLTM-Config with the received ltm-ReferenceConfiguration;
2> else:
3> store the received ltm-ReferenceConfiguration in VarLTM-Config.
1> if the received LTM-Config includes ltm-ServingCellNoResetID:
2> if the current VarLTM-ServingCellNoResetID includes an ltm-ServingCellNoResetID:
3> replace the ltm-ServingCellNoResetID value within VarLTM-ServingCellNoResetID with the received ltm-ServingCellNoResetID;
2> else:
3> store the received ltm-ServingCellNoResetID in VarLTM-ServingCellNoResetID;
1> if the received LTM-Config includes ltm-ServingCellUE-MeasuredTA-ID:
2> if the current VarLTM-ServingCellUE-MeasuredTA-ID includes an ltm-ServingCellUE-MeasuredTA-ID:
3> replace the ltm-ServingCellUE-MeasuredTA-ID value within VarLTM-ServingCellUE-MeasuredTA-ID with the received ltm-Serving CellUE-MeasuredTA-ID; 2> else:
3> store the received ltm-ServingCellUE-MeasuredTA-ID in VarLTM-ServingCellUE-MeasuredTA-ID;
1> if the LTM-Config includes the ltm-CandidateToAddModList:
2> perform the LTM candidate cell addition or reconfiguration;
1> else if the LTM-Config includes the ltm-CandidateToReleaseList:
2> perform the LTM candidate cell release.

To perform the LTM candidate cell release, the UE shall:
1> for each ltm-CandidateId value included in the ltm-CandidateToReleaseList:
2> if the current VarLTM-Config includes an LTM-Candidate associated with the ltm-CandidateId value:
3> remove the entry related to LTM-Candidate from VarLTM-Config;

To perform the LTM candidate cell addition and/or modification, the UE shall:
1> for each ltm-CandidateId value in the ltm-CandidateToAddModList:
2> if the current VarLTM-Config includes an LTM-Candidate with the ltm-CandidateId value:
3> replace the LTM-Candidate within VarLTM-Config in accordance with the received LTM-Candidate;
2> else:
3> add the received LTM-Candidate to VarLTM-Config.
2> generate a complete LTM configuration.

The generation of the complete LTM configuration is a procedure for the UE to generate a complete configuration for LTM to be stored upon it is generated and applied only when an indication of an LTM cell switch is received by lower layers. During the generation of the complete configuration for LTM, the UE shall not modify its current configuration.

To generate the complete LTM configuration, the UE shall:
1> if the LTM-Candidate includes ltm-ConfigComplete:
2> consider that the related ltm-CandidateConfig in the LTM-Candidate is a complete configuration for LTM;
1> else:
2> generate a complete configuration for LTM, by applying the related ltm-CandidateConfig on top of ltm-referenceConfiguration.
2> consider the configuration in ltm-referenceConfiguration as the complete configuration for LTM.

In some implementations, the UE may postpone the generation of a complete LTM configuration until the executing of an LTM cell switch.

In step S907, the UE transmits an RRCReconfigurationComplete message to the gNB.

In some implementations, the UE performs DL synchronization with the LTM candidate cell(s) before receiving the cell switch command.

In some implementations, the UE may perform UL synchronization with LTM candidate cell(s) before receiving the cell switch command, by using UE-based TA measurement, if configured, and/or by transmitting a preamble towards the candidate cell, as triggered by the gNB. When UE-based TA measurement is configured, UE acquires the TA value(s) of the candidate cell(s) by measurement. Otherwise, UE performs early TA acquisition with the candidate cell(s) as requested by the network before receiving the cell switch command. This is done via CFRA triggered by a PDCCH order from the source cell, following which the UE sends preamble towards the indicated candidate cell. In order to minimize the data interruption of the source cell due to CFRA towards the candidate cell(s), the UE doesn't receive random access response from the network for the purpose of TA value acquisition and the TA value of the candidate cell is indicated in the cell switch command. The UE doesn't maintain the TA timer for the candidate cell and relies on network implementation to guarantee the TA validity.

In step S909, the UE performs L1 measurements on the configured LTM candidate cell(s) and transmits L1 measurement reports to the gNB. The L1 measurement should be performed as long as RRC reconfiguration (i.e., RRCReconfiguration) is applicable.

In step S911, the gNB decides to execute cell switch to a target cell.

In step S913, the gNB transmits an LTM cell switch command MAC CE triggering cell switch by including a target configuration ID which indicates the index of the candidate configuration of the target cell (corresponds to ltm-CandidateId), a beam (or, SSB/CSI-RS) indicated with a TCI state or beams indicated with DL and UL TCI states, and a timing advance command for the target cell, if available. The UE switches to the target cell and applies a configuration of the target cell for LTM (i.e., ltm-Candidate Config) indicated by the target configuration ID.

Upon the indication by lower layers that an LTM cell switch procedure is triggered (e.g., upon receiving the LTM cell switch command MAC CE), the UE shall:
1> use the default values specified in 9.2.3 for timers T310, T311 and constants N310, N311 associate to cell group for which the LTM cell switch procedure is triggered;
1> apply the default L1 parameter values as specified in corresponding physical layer specifications;
1> if the value of field ltm-NoResetID contained within the LTM-Candidate IE in VarLTM-Config indicated by lower layers or for the selected cell in accordance with 5.3.7.3 is equal to the value of ltm-ServingCellNoResetID within VarLTM-ServingCellNoResetID:
2> continue using the current RLC entity in the LTM candidate configuration indicated by lower layers;
1> else:
2> for each logicalChannelId and logicalChannelIdExt that is part of the current UE configuration for the cell group for which the LTM cell switch procedure is triggered:
3> re-establish the corresponding RLC entity;
2> for each drb-Identity value that is part of the current UE configuration:
3> trigger the PDCP entity of this DRB to perform data recovery;
2> replace the value of ltm-ServingCellNoResetID in VarLTM-ServingCellNoResetID with the value of ltm-NoResetID in the LTM-Candidate in VarLTM-Config indicated by lower layers or for the selected cell;
1> if the value of ltm-UE-MeasuredTA-ID contained within the LTM-Candidate IE in VarLTM-Config indicated by lower layers or for the selected cell is equal to the value of ltm-ServingCellUE-MeasuredTA-ID within VarLTM-ServingCellUE-MeasuredTA-ID:
2> inform lower layers that UE should perform UE-based TA measurements;
2> replace the value of ltm-ServingCellUE-MeasuredTA-ID in VarLTM-ServingCellUE-MeasuredTA-ID with the value received within ltm-UE-MeasuredTA-ID;
1> else:
2> replace the value of ltm-ServingCellUE-MeasuredTA-ID in VarLTM-ServingCellUE-MeasuredTA-ID with the value of ltm-UE-MeasuredTA-ID in the LTM-Candidate in VarLTM-Config indicated by lower layers or for the selected cell;

In some implementations, the UE performs the UE-based TA measurements upon execution and/or configuration.
1> continue using the current PDCP entity in the LTM candidate configuration indicated by lower layers;
1> if ltm-ConfigComplete is not included within the LTM-Candidate IE in VarLTM-Config indicated by lower layers or for the selected cell:
2> consider ltm-ReferenceConfiguration in VarLTM-Config, associated with the cell group for which the LTM cell switch procedure is triggered, to be the current UE configuration;

When the UE considers the reference configuration to be the current UE configuration, the UE should store fields and configurations that are part of the reference configuration but should not execute any actions or procedures triggered by the reception of an RRCReconfiguration message.
1> if the LTM cell switch is triggered by an indication from lower layers:
2> apply the LTM configuration in ltm-CandidateConfig within LTM-Candidate IE in VarLTM-Config identified by the LTM candidate configuration identity as received from lower layers (i.e., ltm-CandidateId indicated by the cell switch command).
1> consider the LTM candidate cell indicated by lower layers to be the serving cell;

When ltm-ConfigComplete is not included for an LTM candidate configuration, before an LTM cell switch is triggered, the UE may generate and store an RRC reconfiguration message by applying the received LTM candidate configuration on top of the LTM reference configuration, and the stored RRC reconfiguration message is applied when the LTM cell switch is triggered.

In step S915, UE may detach from the source cell, and apply the target cell configuration(s).

In some implementations, the UE performs the random access procedure towards the target cell, if UE does not have valid TA of the target cell. If UE has valid TA of the target cell, the UE may skip the random access procedure towards the target cell (i.e., RACH-less LTM).

When performing the random access procedure/RACH procedure: i) the UE may perform a contention-free random access (CFRA) if CFRA resources/dedicated RACH configuration is available to the UE; and ii) the UE may perform a contention-based random access (CBRA) if CFRA resources/dedicated RACH configuration is not available to the UE.

For the CBRA, the UE may transmit a random access preamble in uplink, to a RAN node. The UE may transmit a message 1 (MSG1) comprising the random access preamble to the RAN node. The random access preamble may be associated with a random access-radio resource temporary identifier (RA-RNTI). The random access preamble may be selected based on the selected RACH resources, and transmitted through a time/frequency resources identified by the selected RACH resources.

For the CFRA, the UE may transmit a dedicated random access preamble in uplink, to a RAN node. The UE may transmit an MSG1 comprising the dedicated random access preamble to the RAN node. The dedicated random access preamble may be associated with a RA-RNTI. The dedicated random access preamble may be selected based on the CFRA resources/dedicated RACH configuration, and transmitted through a time/frequency resources identified by the CFRA resources/dedicated RACH configuration.

In step S917, the UE completes the LTM cell switch procedure by sending RRCReconfigurationComplete message to target cell. If the UE has performed a RA procedure, the UE considers that LTM cell switch execution is successfully completed when the random access procedure is successfully completed. For RACH-less LTM, the UE considers that LTM cell switch execution is successfully completed when the UE determines that the network has successfully received its first UL data. The UE determines successful reception of its first UL data by receiving a PDCCH addressing the UE's C-RNTI in the target cell, which schedules a new transmission following the first UL data. The PDCCH carries either a DL assignment or an UL grant addressing the same HARQ process as the first UL data.

To complete the LTM cell switch procedure, the UE shall:
1> if the RRCReconfiguration message including the LTM-Candidate IE related to the LTM candidate configuration identity as received by lower layers was received via SRB1 within the nr-SCG within mrdc-SecondaryCellGroup (UE in NR-DC):
2> submit the RRCReconfigurationComplete message via the NR MCG embedded in NR RRC message ULInformationTransferMRDC;
1> else if RRCReconfiguration message including the LTM-Candidate IE related to the LTM candidate configuration identity as received by lower layers was received via SRB3 (UE in NR-DC):
2> submit the RRCReconfigurationComplete message via SRB3 to lower layers for transmission using the new configuration;
1> else (RRCReconfiguration was received via SRB1):
2> submit the RRCReconfigurationComplete message to lower layers for transmission via SRB1 using the new configuration.

Hereinafter, measurements on reference signals (RSs) are described.

The UE may receive RSs through a plurality of beams from the serving cell and/or neighbor cell(s), where each of the RSs is received through a corresponding beam. There may be RSs of multiple types—for example, RSs of a first type (e.g., synchronization signal (SS)/physical broadcast channel (PBCH) block (SSB)), and/or RSs of a second type (e.g., channel state information (CSI)—RS). That is, there may be multiple RS types comprising the first type and the second type, where RS of the first type may be SSB, and RS of the second type may be CSI-RS.

Each RS may be transmitted/received on a corresponding RS resource. For example, RS of the first type (e.g., SSB) may be transmitted/received on a resource related to the RS of the first type (e.g., SSB resource), and RS of the second type (e.g., CSI-RS) may be transmitted/received on a resource related to the RS of the second type (e.g., CSI-RS resource).

The UE may perform measurements (e.g., L1 measurements) on the RSs received through the plurality of beams from the serving cell and/or the neighbor cells, and obtain measurement results for the RSs. For example, the UE may transmit measurement report (e.g., L1 measurement report) comprising the measurement results to network. For another example, the UE may perform a mobility to a target cell among the neighbor cell(s) based on the measurement results.

Meanwhile, UE may be configured with event condition to trigger reporting of measurement results of reference signals or to trigger mobility to a target cell. For the event condition, UE may be configured with multiple reference signals to be measured and/or compared, where each reference signal is related to a serving cell and/or a neighbour cell. For different types of reference signals, different/separate event threshold should be configured. For example, if event condition evaluation is to be based on SSB measurement results, SSB-related threshold should be used for the evaluation, and if event evaluation is to be based on CSI-RS measurement results, CSI-RS-related threshold should be used for the event evaluation.

If event condition is configured for a single and/or fixed type of reference signals, the event condition may be applicable only when measurement results of the reference signals of the same type are available. For example, if UE is configured with event condition only for CSI-RS type of reference signals, the event condition may become completely inapplicable whenever UE skips measuring CSI-RS reference signals, even if the UE has SSB measurement results that could be possibly used for evaluating the event condition.

To address the above restriction, one may consider configuring UE with separate event conditions corresponding to different types of reference signals, with the same triggering action upon satisfaction of each of the two event conditions. However, such separate configuration of event conditions may prevent UE from applying a certain (or NW-preferred) event condition corresponding to a certain (or NW-preferred) type of reference signals for the evaluation, because each event condition is evaluated independent of the evaluation of other event condition. For example, network may prefer UE to use CSI-RS based evaluation whenever possible for a mobility to a neighbour cell since CSI-RS based evaluation provides finer granularity of the channel quality than SSB-based evaluation. But, even if the UE has both SSB measurements and CSI measurement of the neighbor cell, such separate configuration of SSB-based event condition and CSI-RS based event condition cannot enforce CSI-RS based evaluation, because SSB-based event condition can be met independent of the CSI-RS based evaluation.

Therefore, in the present disclosure, event condition evaluation based on RS type is described.

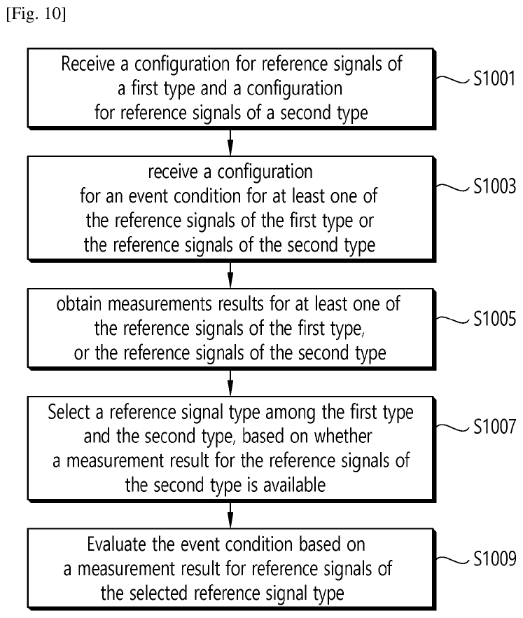

FIG. 10 shows an example of a method performed by a communication device for event condition evaluation based on RS type according to an embodiment of the present disclosure.

Referring to FIG. 10, in step S1001, the communication device may receive a configuration for reference signals of a first type and a configuration for reference signals of a second type.

In step S1003, the communication device may receive a configuration for an event condition for at least one of the reference signals of the first type or the reference signals of the second type.

In step S1005, the communication device may obtain measurements results for at least one of the reference signals of the first type, or the reference signals of the second type.

In step S1007, the communication device may select a reference signal type among the first type and the second type, based on whether a measurement result for the reference signals of the second type is available.

In step S1009, the communication device may evaluate the event condition based on a measurement result for reference signals of the selected reference signal type.

According to various embodiments, based on the measurement result for the reference signals of the second type being unavailable, the first type may be selected as the reference signal type. The communication device may evaluate the event condition based on a measurement result for the reference signals of the first type that is selected as the reference signal type.

According to various embodiments, based on the measurement result for the reference signals of the second type being available, the second type may be selected as the reference signal type. The communication device may evaluate the event condition based on a measurement result for the reference signals of the second type that is selected as the reference signal type. Alternatively, the communication device may evaluate the event condition based on the measurement result for the reference signals of the second type that is selected as the reference signal type, and a measurement result for the reference signals of the first type that is not selected as the reference signal type.

According to various embodiments, the communication device may receive a configuration for a measurement triggering criterion. The communication device may perform a measurement on the reference signals of the first type. The communication device may perform a measurement on the reference signals of the second type based on the measurement triggering criterion being met. For example, the measurement triggering criterion may be met based on a measurement quality of the reference signals of the first type being above a threshold.

According to various embodiments, a measurement result for the reference signals of the first type is available and the measurement result for the reference signals of the second type is not available. In this case, the communication device may: evaluate the event condition based on the measurement result for the reference signals of the first type; or skipping evaluate the event condition.

According to various embodiments, a measurement result for the reference signals of the first type is not available and the measurement result for the reference signals of the second type is available. In this case, the communication device may: evaluate the event condition based on the measurement result for the reference signals of the second type; or skip evaluating the event condition.

According to various embodiments, a measurement result for the reference signals of the first type is available and the measurement result for the reference signals of the second type is available. In this case, the communication device may evaluate the event condition based on at least one of the measurement result for the reference signals of the first type or the measurement result for the reference signals of the second type. When the event condition is evaluated based on the measurement result for the reference signals of the first type and the measurement result for the reference signals of the second type, the event condition is met based on at least one of the measurement result for the reference signals of the first type meeting the event condition, or the measurement result for the reference signals of the second type meeting the event condition.

According to various embodiments, the event condition may comprise at least one of: a first condition that is evaluated based on the reference signals of the first type; a second condition that is evaluated based on the reference signals of the second type; or a third condition that is evaluated based on at least one of the reference signals of the first type or the reference signals of the second type.

According to various embodiments, a resource related to the reference signals of the first type may be quasi co-located (QCL′ed) with respect to a resource related to the reference signals of the second type.

According to various embodiments, the reference signals of the first type may comprise synchronization signal/physical broadcast channel blocks (SSBs). The reference signals of the second type may comprise channel state information—reference signals (CSI-RSs).

According to various embodiments, based on the event condition being met, the communication device may transmit, to a network, a measurement report comprising the measurement result for the reference signals of the selected reference signal type. The measurement report may further comprise a measurement result for reference signals of a reference signal type that is not selected among the first type and the second type.

According to various embodiments, based on the event condition being met, the communication device may perform a mobility to a target cell from which the reference signals of the selected reference signal type are received.

FIG. 11 shows an example of a signal flow between a communication device and a network node for event condition evaluation based on RS type according to an embodiment of the present disclosure.

Referring to FIG. 11, in step S1101, the network node may transmit, to the communication device, a configuration for reference signals of a first type and a configuration for reference signals of a second type.

In step S1103, the network node may transmit, to the communication device, a configuration for an event condition for at least one of the reference signals of the first type or the reference signals of the second type.

In step S1105, the communication device may obtain measurements results for at least one of the reference signals of the first type, or the reference signals of the second type.

In step S1107, the communication device may select a reference signal type among the first type and the second type, based on whether a measurement result for the reference signals of the second type is available.

In step S1109, the communication device may evaluate the event condition based on a measurement result for reference signals of the selected reference signal type.

Hereinafter, detailed implementations regarding event condition evaluation based on a reference signal (RS) type are described.

In the present disclosure, “CSI resource” and “RS resource” can be used interchangeably.

In the present disclosure, UE may be configured with event condition including multiple thresholds corresponding to multiple RS types. Then, UE may select applicable threshold(s) (e.g., by selecting applicable RS type(s)) for evaluation of the event condition based on available measurement results. The event condition may be used by UE to trigger measurement report comprising the measurement results for the reference signals or to trigger mobility to a target cell.

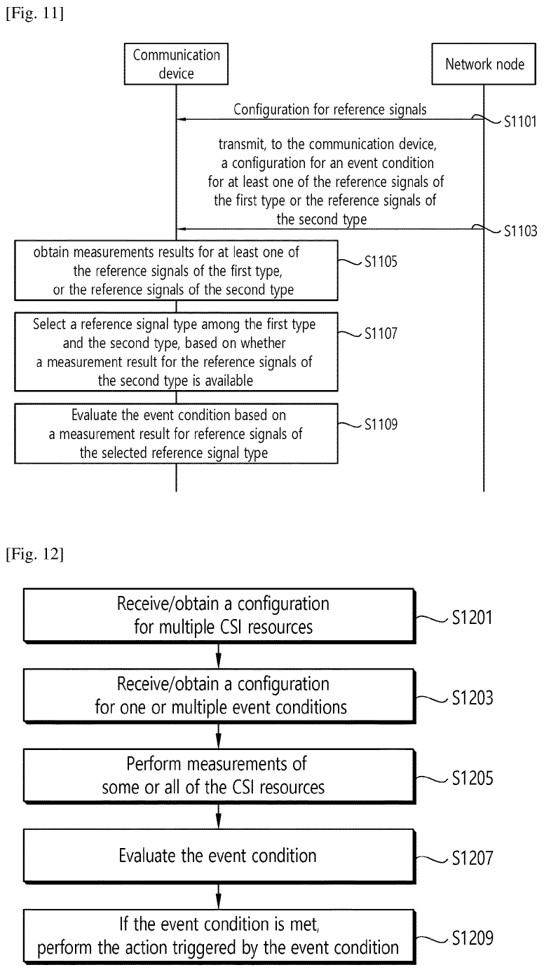

FIG. 12 shows an overall procedure for event condition evaluation according to an embodiment of the present disclosure.

Referring to FIG. 12, in step S1201, the UE may receive/obtain a configuration for multiple RS resources. The UE may be configured with multiple RS resources. The RS resources may not be of the same resource type. For example, some RS resources may be resources of a first type (e.g., SSB type and/or common signalling based RS type), and other RS resources may be resources of a second type (e.g., CSI-RS and/or dedicated signalling based RS).

In step S1203, the UE may receive/obtain a configuration for one or multiple event conditions. The UE may be configured with one or multiple event conditions. The event condition may include a first sub-condition for the first RS type (i.e., RS related to the first type) and a second sub-condition for the second RS type (i.e., RS related to the second type).

The event condition may be a condition of triggering measurement reporting comprising the measurement result for the RS.

The event condition may be a condition of triggering mobility to a cell associated with the RS.

In step S1205, the UE may perform measurements of some or all of the RS resources.

When performing measurements, the following alternatives (Alts) may be considered:
Alt M1) UE may perform RS resources of the first type (e.g., SSB resource) by default, and UE may perform a subset of RS resources of the second type (e.g., CSI-RS resource). UE may select the subset of RS resources of the second type to measure based on the measurement results of the RS resources of the first type; and/or
Alt M2) UE may perform a subset of RS resources of the first type (e.g., SSB resource), and UE perform a subset of RS resources of the second type (e.g., CSI-RS resource) based on a measurement RS reselection rule.

In step S1207, the UE may evaluate the event condition. When evaluating the event condition, UE may select applicable RS type(s) for the event condition based on the availability of the measurement results for the RS types and/or sub-conditions included in the event condition.

When evaluating the event condition, the following alternatives may be considered:
Alt Eval1) UE may check if measurement result for the second type (e.g., measurement result for RS related to the second type) is available. If the measurement result for the second type is available, UE may evaluate the second sub-condition for the event condition without evaluating the first sub-condition, and if the second sub-condition is met, UE may consider that the event condition is met. If the measurement result of the second type is not available, UE may evaluate the first sub-condition for the event condition without evaluating the second sub-condition, and if the first sub-condition is met, UE may consider that the event condition is met; and/or
Alt Eval2) If the measurement result for the first type (e.g., measurement result for RS related to the first type) is available, UE may evaluate the first sub-condition for the event condition. If the measurement result of the second type (e.g., measurement result for RS related to the second type) is available, UE may evaluate the second sub-condition for the event condition. If the first sub-condition and the second sub-condition are both satisfied, UE may consider that the event condition is met.
Alt Eval3) If measurement result for RS related to the first type is available and measurement result for RS related to the second type is also available, UE may evaluate the event condition based on the measurement result for RS related to the first type and the measurement result for RS related to the second type. UE may consider that the event condition is met if the measurement result for RS related to the first type meets the event condition, and/or the measurement result for RS related to the second type meets the event condition.

In step S1209, if the event condition is met, UE may perform the action triggered by the event condition.

Alternatively, two separate events may be configured, one for the first type and the other for the second type, and UE may select applicable event(s) to trigger a common procedure.

These separate event conditions may be associated by having a common association flag in each event configuration/condition or having a flag in one event configuration/condition, where the flag indicates the other event condition as associated event condition.

In some implementations, as similar to Alt Eval1), if UE has measurement results for the RS related to the second type, UE may apply the event condition for the RS related to the second type for the evaluation without applying the event condition for the RS related to the first type. If the event condition for the RS related to the second type is met, UE may perform the triggered procedure.

In some implementations, as similar to Alt Eval2), if UE has measurement results for the RS related to both types, UE may jointly apply the event conditions for the first type and the event condition for the second type. If both the event condition for the RS related to the first type and the event condition for the RS related to the second type are met, UE may perform the triggered procedure.

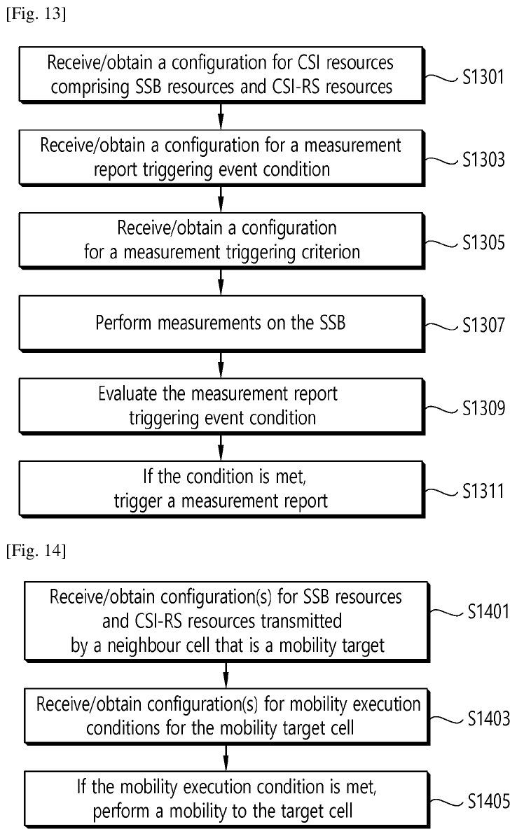

FIG. 13 shows a first example of a procedure for event condition evaluation according to an embodiment of the present disclosure.

Referring to FIG. 13, in step S1301, UE may receive/obtain a configuration for RS resources comprising SSB resources and CSI-RS resources. The UE may be configured with RS resources comprising SSB resources and CSI-RS resources.

Each RS resource can be classified as:
a reference RS resource of one or more other (associated) RS resources; or
a non-reference RS resource that uses other (associated) RS resource as a reference CSI reference.

For example, (some) SSB resources may be configured as reference RS resources of other RS resources.

In step S1303, the UE may receive/obtain a configuration for a measurement report triggering event condition. The UE may be configured with a configuration for a measurement report triggering event condition. The condition may be related to both an SSB resource of the configured SSB resources and a CSI-RS resource of the configured CSI-RS resources. The condition may include at least one of an SSB-related threshold or a CSI-RS-related threshold.

In step S1305, the UE may receive/obtain a configuration for a measurement triggering criterion. UE may be configured with a measurement triggering criterion. For example, the criterion may be such that if measurement quality of a reference RS resource is above a threshold, the criterion is met.

A reference RS resource and a non-reference RS resource that uses the reference RS resource as reference may be desirably quasi-co-located (QCL′ed) i.e., they experience similar channel properties and/or they are transmitted/received through the same beam.

In step S1307, the UE may perform measurements on the SSB.

If the measurement result for the SSB satisfies the measurement triggering criterion, UE may perform measurements on CSI-RSs associated with the SSB. If the measurement result for the SSB does not satisfy the measurement triggering criterion, UE may skip performing measurements on CSI-RSs associated with the SSB.

In step S1309, the UE may evaluate the measurement report triggering event condition.

In the measurement report triggering based on Alt Eval1, if the CSI-RS measurement result related to the condition is available, UE may select the CSI-RS related threshold for the evaluation. If the measurement result for the CSI-RS is not available, UE may select the SSB-related threshold for the evaluation.

In the measurement report triggering based on Alt Eval2, if the SSB measurement result related to the condition is available, UE may select the SSB-related threshold for the evaluation. If the CSI-RS measurement result related to the condition is available, UE may select the CSI-RS related threshold for the evaluation. If any of the measurement result for the SSB and/or the measurement result for the CSI-RS is not available, UE may consider that the condition is not met.

In step S1311, if the condition is met, UE may trigger a measurement report.

In the measurement report triggering based on Alt Eval1, if the condition is met based on the selected threshold, UE may trigger a measurement report. The measurement report may include measurement results for the CSI-RS. The measurement report may include the measurement results for the SSB associated with the CSI-RS.

In the measurement report triggering based on Alt Eval2, if the condition is met based on the selected thresholds (i.e., both SSB measurement result satisfies the SSB-related condition based on the SSB-related threshold and the CSI-RS measurement result satisfies the CSI-RS-related condition based on the CSI-RS related threshold), UE may trigger a measurement report. The measurement report may include measurement results of the CSI-RS and the SSB.

FIG. 14 shows a second example of a procedure for event condition evaluation according to an embodiment of the present disclosure.

Referring to FIG. 14, in step S1401, UE may receive/obtain configuration(s) for SSB resources and CSI-RS resources transmitted by a neighbour cell that is a mobility target. The UE may be configured with SSB resources and CSI-RS resources transmitted by the neighbour cell that is the mobility target.

In step S1403, the UE may receive/obtain configuration(s) for mobility execution conditions for the mobility target cell. The UE may be configured with the mobility execution conditions for the mobility target cell.

The condition may involve the following partial conditions and/or the following joint conditions.

For example, partial condition for a target cell may be defined as follows:
UE may determine/select a RS set (or, RS resource set) related to the target cell (for event condition evaluation purpose).

In some implementations, the RS set may comprise one or more RS resources (e.g., SSB resources/CSI-RS resources) related to the target cell explicitly indicated by network for the partial condition.

In some implementations, the RS set may comprise RS resources (e.g., SSB resources/CSI-RS resources) configured for neighbour cell L1 measurements whose quality is above a threshold.

In some implementations, the RS set may comprise one or more reference RS resources (e.g., SSB resources/CSI-RS resources) related to the currently activated TCI state for the target cell.

In the above, the maximum number of RSs/beams to be included in the RS set related to the target cell can be upper-bounded.
UE may derive the representative RS quality of the target cell as: the best quality RS in the RS set related to the target cell; average quality of best K RSs in the RS set related to the target cell; average quality of RSs in the RS set related to the target cell; and/or the worst quality RS in the RS set related to the target cell. When deriving the representative RS quality of the target cell, UE may select an RS type. If CSI-RS measurement results are available for the all RSs required to derive the representative RS quality of the target cell, UE may use the CSI-RS measurement results for the derivation. Else, UE may use the SSB measurements for the derivation.
UE may consider that the partial condition is met if the representative RS quality of the target cell is higher a threshold.

For example, partial condition for a source cell may be defined as follows:
UE may determine/select a RS set (or, RS resource set) related to the source cell (for event condition evaluation purpose).

In some implementations, the RS set may comprise one or more RS resources (e.g., SSB resources/CSI-RS resources) related to the source cell explicitly indicated by network for the partial condition.

In some implementations, the RS set may comprise one or more reference RS resources (e.g., SSB resources/CSI-RS resources) related to the currently activated TCI state and/or indicated TCI state for the serving cell.

In some implementations, the RS set may comprise RSs (e.g., beams/SSBs/CSI-RSs) related to the source cell whose quality is above a threshold.

In the above, the maximum number of RSs/beams to be included in the RS set related to the source cell can be upper-bounded.
UE may derive the representative RS quality of the source cell as: the best quality RS in the RS set related to the source cell; average quality of best K RSs in the RS set related to the source cell; average quality of RSs in the RS set related to the source cell; and/or the worst quality RS in the RS set related to the source cell. When deriving the representative RS quality of the source cell, UE may select an RS type. If CSI-RS measurement results are available for the all RSs required to derive the representative RS quality of the source cell, UE may use the CSI-RS measurement results for the derivation. Else, UE may use the SSB measurements for the derivation.
UE may consider that the partial condition is met if the representative RS quality of the source cell is below a threshold.

For example, joint condition for the source cell and the target cell may be defined as follows:
UE may consider that the joint condition is met if the partial condition for the source cell is met and the partial condition for the target cell is met; and/or
UE may consider that the joint condition is met if the representative RS quality of the target cell is a threshold higher than the representative RS quality of the source cell. When comparing the representative RS quality between the source cell and the target cell, if CSI-RS measurement results are available for the all RSs required to derive the representative RS quality for the source cell and the target cell, UE uses the CSI-RS measurement results for the comparison. Else, UE may use the SSB measurements for the comparison.

In step S1405, if the mobility execution condition is met, UE may perform a mobility to the target cell. UE may apply the configuration of the target cell. If the UE has necessary information (e.g., beam information to be used for target cell access, and/or uplink timing control information used for synchronizing to the target cell) required to execute RACH-less mobility, UE may perform RACH-less mobility. Else, the UE may perform RACH-based mobility.

According to various embodiments, the UE may receive a configuration including a first type of reference signals and a second type of reference signals. The UE may receive an event condition related to at least one reference signal of the first type and at least one reference signal of the second type. The even condition may include a first threshold related to the first type of reference signals and a second threshold related to the second type of reference signals. The UE may perform measurements on at least one reference signals related to the event condition. Based on availability of the measurement results for the second type of reference signals, the UE may select a reference signal type among the first type and the second type. The UE may evaluate the event condition based on applying the selected reference signal type.

Furthermore, the method in perspective of the UE described in the present disclosure (e.g., in FIG. 10) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving a configuration for reference signals of a first type and a configuration for reference signals of a second type; receiving a configuration for an event condition for at least one of the reference signals of the first type or the reference signals of the second type; obtaining measurements results for at least one of the reference signals of the first type, or the reference signals of the second type; selecting a reference signal type among the first type and the second type, based on whether a measurement result for the reference signals of the second type is available; and evaluating the event condition based on a measurement result for reference signals of the selected reference signal type.

Furthermore, the method in perspective of the UE described in the present disclosure (e.g., in FIG. 10) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving a configuration for reference signals of a first type and a configuration for reference signals of a second type; receiving a configuration for an event condition for at least one of the reference signals of the first type or the reference signals of the second type; obtaining measurements results for at least one of the reference signals of the first type, or the reference signals of the second type; selecting a reference signal type among the first type and the second type, based on whether a measurement result for the reference signals of the second type is available; and evaluating the event condition based on a measurement result for reference signals of the selected reference signal type.

Furthermore, the method in perspective of the UE described in the present disclosure (e.g., in FIG. 10) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., communication device/UE) comprises at least processor, and at least one computer memory operably connectable to the at least one processor. The at least one processor is configured to/adapted to perform operations comprising: receiving a configuration for reference signals of a first type and a configuration for reference signals of a second type; receiving a configuration for an event condition for at least one of the reference signals of the first type or the reference signals of the second type; obtaining measurements results for at least one of the reference signals of the first type, or the reference signals of the second type; selecting a reference signal type among the first type and the second type, based on whether a measurement result for the reference signals of the second type is available; and evaluating the event condition based on a measurement result for reference signals of the selected reference signal type.

Furthermore, the method in perspective of a network node described in the present disclosure (e.g., in FIG. 11) may be performed by the second wireless device 200 shown in FIG. 2. The network node may be related to a serving cell.

More specifically, the network node comprises at least one transceiver, at least processor, and at least one computer memory operably connectable to the at least one processor and storing instructions that, based on being executed by the at least one processor, perform operations.

The operations comprise: transmitting, to a communication device, a configuration for reference signals of a first type and a configuration for reference signals of a second type; and transmitting, to the communication device, a configuration for an event condition for at least one of the reference signals of the first type or the reference signals of the second type, wherein the communication device is configured to perform operations comprising: obtaining measurements results for at least one of the reference signals of the first type, or the reference signals of the second type; selecting a reference signal type among the first type and the second type, based on whether a measurement result for the reference signals of the second type is available; and evaluating the event condition based on a measurement result for reference signals of the selected reference signal type.

The present disclosure may have various advantageous effects.

For example, since UE evaluates whether to trigger a measurement report based on a desirable RS, the measurement result beneficial to network can be triggered.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving a configuration for reference signals of a first type and a configuration for reference signals of a second type;
receiving a configuration for an event condition for at least one of the reference signals of the first type or the reference signals of the second type;
obtaining measurements results for at least one of the reference signals of the first type, or the reference signals of the second type;
selecting a reference signal type among the first type and the second type, based on whether a measurement result for the reference signals of the second type is available; and
evaluating the event condition based on a measurement result for reference signals of the selected reference signal type.

2. The method of claim 1, wherein, based on the measurement result for the reference signals of the second type being unavailable, the first type is selected as the reference signal type, and
wherein the evaluating of the event condition comprises evaluating the event condition based on a measurement result for the reference signals of the first type that is selected as the reference signal type.

3. The method of claim 1, wherein, based on the measurement result for the reference signals of the second type being available, the second type is selected as the reference signal type, and
wherein the evaluating of the event condition comprises evaluating the event condition based on a measurement result for the reference signals of the second type that is selected as the reference signal type.

4. The method of claim 3, wherein the evaluating of the event condition comprises evaluating the event condition based on the measurement result for the reference signals of the second type that is selected as the reference signal type, and a measurement result for the reference signals of the first type that is not selected as the reference signal type.

5. The method of claim 1, further comprising:
receiving a configuration for a measurement triggering criterion;
performing a measurement on the reference signals of the first type; and
performing a measurement on the reference signals of the second type based on the measurement triggering criterion being met.

6. The method of claim 1, wherein a measurement result for the reference signals of the first type is available and the measurement result for the reference signals of the second type is not available, and
wherein the evaluating of the event condition comprises:
evaluating the event condition based on the measurement result for the reference signals of the first type; or
skipping evaluating the event condition.

7. The method of claim 1, wherein a measurement result for the reference signals of the first type is not available and the measurement result for the reference signals of the second type is available, and
wherein the evaluating of the event condition comprises:
evaluating the event condition based on the measurement result for the reference signals of the second type; or
skipping evaluating the event condition.

8. The method of claim 1, wherein a measurement result for the reference signals of the first type is available and the measurement result for the reference signals of the second type is available, and
wherein the evaluating of the event condition comprises evaluating the event condition based on at least one of the measurement result for the reference signals of the first type or the measurement result for the reference signals of the second type.

9. The method of claim 8, wherein the event condition is evaluated based on the measurement result for the reference signals of the first type and the measurement result for the reference signals of the second type, and
wherein the event condition is met based on at least one of the measurement result for the reference signals of the first type meeting the event condition, or the measurement result for the reference signals of the second type meeting the event condition.

10. The method of claim 1, wherein the event condition comprises at least one of:
a first condition that is evaluated based on the reference signals of the first type;
a second condition that is evaluated based on the reference signals of the second type; or
a third condition that is evaluated based on at least one of the reference signals of the first type or the reference signals of the second type.

11. The method of claim 1, wherein a resource related to the reference signals of the first type are quasi co-located (QCL′ed) with respect to a resource related to the reference signals of the second type.

12. The method of claim 1, wherein the reference signals of the first type comprise synchronization signal/physical broadcast channel blocks (SSBs), and
wherein the reference signals of the second type comprise channel state information-reference signals (CSI-RSs).

13. The method of claim 1, further comprising:
based on the event condition being met, transmitting, to a network, a measurement report comprising the measurement result for the reference signals of the selected reference signal type.

14. The method of claim 13, wherein the measurement report further comprises a measurement result for reference signals of a reference signal type that is not selected among the first type and the second type.

15. The method of claim 1, further comprising:
based on the event condition being met, performing a mobility to a target cell from which the reference signals of the selected reference signal type are received.

16. The method of claim 1, wherein the method is performed by a communication device in communication with at least one of a mobile device, a network, or autonomous vehicles.

17. A communication device comprising:
at least one transceiver;
at least one processor; and
at least one memory operatively coupled to the at least one processor and storing instructions that, based on being executed by the at least one processor, perform operations comprising:
receiving a configuration for reference signals of a first type and a configuration for reference signals of a second type;
receiving a configuration for an event condition for at least one of the reference signals of the first type or the reference signals of the second type;
obtaining measurements results for at least one of the reference signals of the first type, or the reference signals of the second type;
selecting a reference signal type among the first type and the second type, based on whether a measurement result for the reference signals of the second type is available; and
evaluating the event condition based on a measurement result for reference signals of the selected reference signal type.

18-20. (canceled)

21. A network node comprising:
at least one transceiver;
at least one processor; and
at least one memory operatively coupled to the at least one processor and storing instructions that, based on being executed by the at least one processor, perform operations comprising:
transmitting, to a communication device, a configuration for reference signals of a first type and a configuration for reference signals of a second type; and
transmitting, to the communication device, a configuration for an event condition for at least one of the reference signals of the first type or the reference signals of the second type,
wherein the communication device is configured to perform operations comprising:
obtaining measurements results for at least one of the reference signals of the first type, or the reference signals of the second type;
selecting a reference signal type among the first type and the second type, based on whether a measurement result for the reference signals of the second type is available; and
evaluating the event condition based on a measurement result for reference signals of the selected reference signal type.
